(19) United States
(12) Patent Application Publication
(10) Pub. No.: US 2010/0211527 A1
(43) Pub. Date: Aug. 19, 2010

(54) BUSINESS DEVELOPMENT COMPANY ORIGINATED REVENUE-LINKED DEBT INSTRUMENTS

(76) Inventors: Christopher Roman, New York, NY (US); David A. Ballard, Darien, CT (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 12/769,258

(22) Filed: Apr. 28, 2010

Related U.S. Application Data
(63) Continuation-in-part of application No. 12/009,515, filed on Jan. 18, 2008.

(51) Int. Cl. G06Q 40/00; G06Q 10/00

(52) U.S. Cl. 705/36 R; 705/38; 705/37

(57) ABSTRACT

Embodiments of the present invention, for the first time, provide methods for financing an asset management firm, by using participating debt securities as the investment engine and then collecting those interests and selling the resultant securities into a Business Development Company.

### CROSS-REFERENCES TO RELATED APPLICATIONS

This application is a continuation in part of U.S. patent application Ser. No. 12/009,515, which was filed on Jan. 18, 2008, which should be incorporated by reference in the present application.

### FIELD OF THE INVENTION

Embodiments of the present invention relates generally to a method and apparatus for financing asset management firms. More specifically, embodiments relate to participating debt security methods for financing an asset management firm or any other financial services firm. Second, in order to monetize this investment, these specific investments will be aggregated and put into a very specific type of entity, a Business Development Company (“BDC”) which allows interests in that entity to be sold to the public markets while maintaining private information about this underlying investment.

Therefore, the structure disclosed can be applied to the asset management industry, involving participating debt securities and a Business Development Company's disposition strategy, which collectively are unique and additive to the market of asset management investments.

### BACKGROUND OF THE INVENTION

Asset management firms, also termed investment management firms, currently lack flexible solutions to their main finance needs. Such needs are often tied to pivotal events during their lifetime, including (1) succession, as founders retire and their equity is recycled; (2) restructuring, as financial investors or lenders are taken out; (3) buyout, as parent companies seek to spin out asset management units, and (4) other liquidity or capital needs for the firm or its owners.

Current finance solutions involve high levels of cultural and consensus risk. For instance, straight borrowing works in pure finance terms, but has acquired a stigma over the years. Few financiers are available, and the amount of firm value that can be monetized is low. Banks often demand recourse and restrictive covenants, which further interfere with the culture of the borrowers.

Additionally, selling a firm in whole or in part is public, final, and often controversial. A high sale price may be needed to compensate for client disruption and publicity. Moreover, cultural problems with the buyer are often insurmountable, particularly in a bear market. Internal inter-generational battles for value may be very stressful, particularly for smaller firms.

Experiences over time have demonstrated that venture investors rarely pay fair price for equity investments in asset management firms. High required returns for venture investors may force onerous terms from venture investment, usually in the form of “claw-backs” of increases in the value of the target firm. While their participation is sometimes discreet, many investors tarnish rather than enhance a firm's image. Management interaction with venture capitalists is often very uncomfortable, especially during tough economic times.

In the past, revenue sharing techniques have been combined with ownership during the term of the revenue share interest to secure financing for asset management firms. In return for financing the asset management firm, the financing entity immediately gains partial or, in some cases, total ownership of the asset management firm and a perpetual share of the firm's revenue stream. In many situations, such techniques may be fundamentally undesirable and unworkable, because they forfeit autonomy of the asset management firm, giving partial or complete control to the financing entity. These techniques concentrate on the investment strategy between the buyer and the selling asset management entity.

Additionally, a major problem in having interests in private asset management companies is how the financier will find liquidity/realized value for that investment.

Previous patented strategies include a self amortizing revenue share interest that simply pays down and goes away and is not debt (Asset Management Finance application Ser. No. 10/805,063). That is a 1) a unique investment structure as well as 2) an answer to finding liquidity as the structure effectively goes away and that value is embedded in the structure.

In general, the public markets are willing to pay the highest price for an ownership interest as the security has liquidity on a national exchange but generally require significant disclosure about the company and its management.

The three part strategy (asset management industry, participating debt security, and a BDC method of monetizing or finding liquidity) is a different front to back answer to this problem of how to make investments in a private industry and then get liquidity for those investments (without disrupting the private operations of the underlying companies).

Several computer based models are used in 1) the evaluation of the asset management company to determine its valuation, 2) a specific computer based model is used to evaluate the appropriate terms of the participating debt security to provide the investor an appropriate return for the nature of the investment, and 3) a computer based model to aggregate the individual participating debt investments and provide quarterly distributions for the BDC and 4) a computer based model to evaluate the participating debt securities which is required by the SEC for a quarterly valuation of assets within a BDC.

Accordingly, there is a need in the art to provide a user to implement the present invention via a described structure which would allow the user to monetize the investment or “sell” the asset in a public offering at the highest price, but not require public disclosure of the underlying asset management companies due to the unique characteristics of the Business Development Company rules. It is also desirous to package the complete front to back method of investing in the asset management industry and make it available to perspective users in the financial industry.

### SUMMARY OF THE INVENTION

The foregoing needs are met, to a great extent, by the present invention, wherein aspects of a mixing assembly start-up method are provided.

The following summary is intended to describe certain embodiments of the present invention. It does not encompass each and every embodiment, and should not be construed as limiting of the present invention.

Embodiments of the present invention, for the first time, provide methods for financing an asset management firm, by using participating debt securities as the investment engine and then collecting those interests and selling the resultant securities into a Business Development Company.

In an embodiment, an entity, such as an asset management firm, needs money to finance some aspect of its business, for example, a succession, restructuring, or buyout event. A financing provider enters into an agreement with the entity. Under the terms of the agreement, the financing provider agrees to give money to the entity. In return, the entity agrees to sell a participating debt security which pays a fixed coupon as well as a share of the entity's future revenue or a interest based on the assets under management (“AUM”). The security is structurally a debt security issued by the asset management company and is a claim against that entity. The financing provider receives no ownership or other controlling interest (no management rights, etc) in the entity during the term of the security but may have the right to convert into the equity interest of the company or into a revenue share interest in the company at maturity.

The financing provider's decision to enter into the agreement with the entity may be informed, evaluated, and priced by use of an analytical model with probabilistic aspects. In particular, the model may receive, as inputs, assumptions relating to the agreement terms, and factors impacting asset values over time. Among other things, the model may apply cash flow analyses (e.g., deterministic analysis, Monte Carlo analysis, and historical sampling analysis), added sensitivity analysis to stress the hypothetical investment, and discounted cash flow analyses. If model results do not meet objective underwriting guidelines, input assumptions may be modified, and the model re-run with the modified assumptions. As a practical matter, the financing provider's decision to enter into an agreement may also consider qualitative factors which fall outside the scope of a model.

Accordingly, embodiments herein provide an entity with the financing it needs, yet preserve the entity's independence and incentive to succeed. Moreover, embodiments provide new sound investment opportunities in the financial industry.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 shows an investment arrangement according to an embodiment of the present invention.

FIG. 2 shows the entire process according to an embodiment of the present invention.

FIG. 3 shows cash flows of the entire process according to an embodiment of the present invention.

FIG. 4 shows the multiple computer based models required for the present invention.

### DETAILED DESCRIPTION

The following description refers to the accompanying drawings that illustrate certain embodiments of the present invention. Other embodiments are possible and modifications may be made to the embodiments without departing from the spirit and scope of the invention. Therefore, the following detailed description is not meant to limit the present invention. Rather, the scope of the present invention is defined by the appended claims.

In an embodiment, a method of financing an entity, such as an asset management firm, is presented. A participating debt security must be sold by the asset management company. The debt security provides that a financing provider is to invest funds in the entity for use by the entity. Additionally, the participating debt security provides that, for a predetermined period of time, the financing provider or other specified party is to receive a fixed coupon as well as participation by way of an predefined share of revenue generated by the entity (i.e., a “revenue participation” or by a predefined payment based on the assets under management (“AUM”) of the entity (i.e., an “AUM participation”). Pursuant to the agreement, no ownership interest in the entity is given to the financing provider or other specified party unless/until a conversion option is exercised into either a direct equity ownership in the entity or a revenue share interest (which may or may not be perpetual in nature) in the entity. To assess the soundness of the potential investment, a probabilistic model-based analysis may be performed before the debt security is purchased. The maturity of the participating convertible debt security will also be determined.

As a debt security, there would be a fixed payment schedule, including a fixed coupon payment, as well as a participation payment. The participation payment would be based on either a fixed percentage of the revenue of the entity (and not any other financial metrics below the revenue line such as earnings or profits) or a payment based on the Assets Under Management (“AUM”) of the entity. The debt security will have a principal amount that is required to be repaid at maturity. Additionally the debt security may have a conversion feature that will allow the holder to determine if the holder wants to accept the repayment of principal or convert the interest into an equity interest in the entity or convert into a revenue share interest in the entity.

No ownership interest during the term of the participating debt security is used in the financing of the target entity. The financier may provide other value added services to enhance its debt investment during the term of the financing. The debt security carries no voting rights, no board representation, no management control, no distribution of profits, and does not constitute an ownership interest. The target financed firm may be an asset management firm, or any other financial services firm.

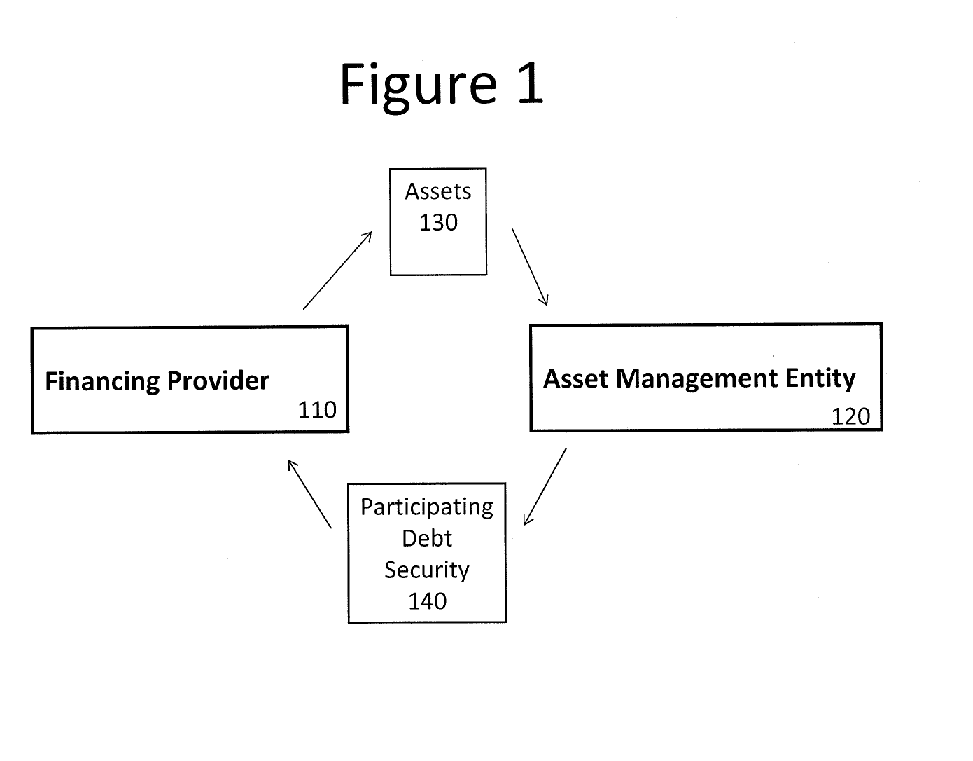

FIG. 1 shows an investment arrangement according to an embodiment of the present invention. The arrangement includes a financing provider 110 that enters into an agreement with an entity 120, such as an asset management firm.

The financing provider 110 has money or other assets 130 to invest in an entity, such as the entity 110. The entity 120 is in need of money or other assets for some reason, such as to fund a succession, restructuring, or buyout event. It is to be appreciated that the terms “financing provider” and “entity” are used herein in a generic sense to denote parties in the arrangement FIG. 1. Although some embodiments herein of the present invention focus on asset management firms, the present invention may be applied to other types of businesses.

The agreement specifies that the financing provider 110 is to provide assets (typically cash) 130 to the entity 110. The assets may also include Cash and cash equivalents, such as currency, deposit accounts, and negotiable instruments (e.g., money orders, check, bank drafts). The assets can include Short-term investments, such as securities bought and held for sale in the near future to generate income on short-term price differences (trading securities) or Receivables or Inventory. The entity 110 is to give the financing provider a participating convertible debt security 140 in the entity 110. No ownership interest in the entity 120 is given to the financing provider 110 during the term of the participating debt security 140.

The participating debt security 140 may have different maturities. The security will have a fixed coupon, which can be different for each entity, as well as have a participation payment. That payment will be based on either a participation in the revenue of the entity or be a function of the AUM. A computer model is required to analyze and compare different combinations of coupons and participation interest in either revenues or AUM. It should be noted that to implement the present invention, special permission or a private letter ruling from a Federal Agency may be required to carry certain aspects of this invention stating that all of the cash flows from these participating debt securities will be deemed “good” income for a BDC.

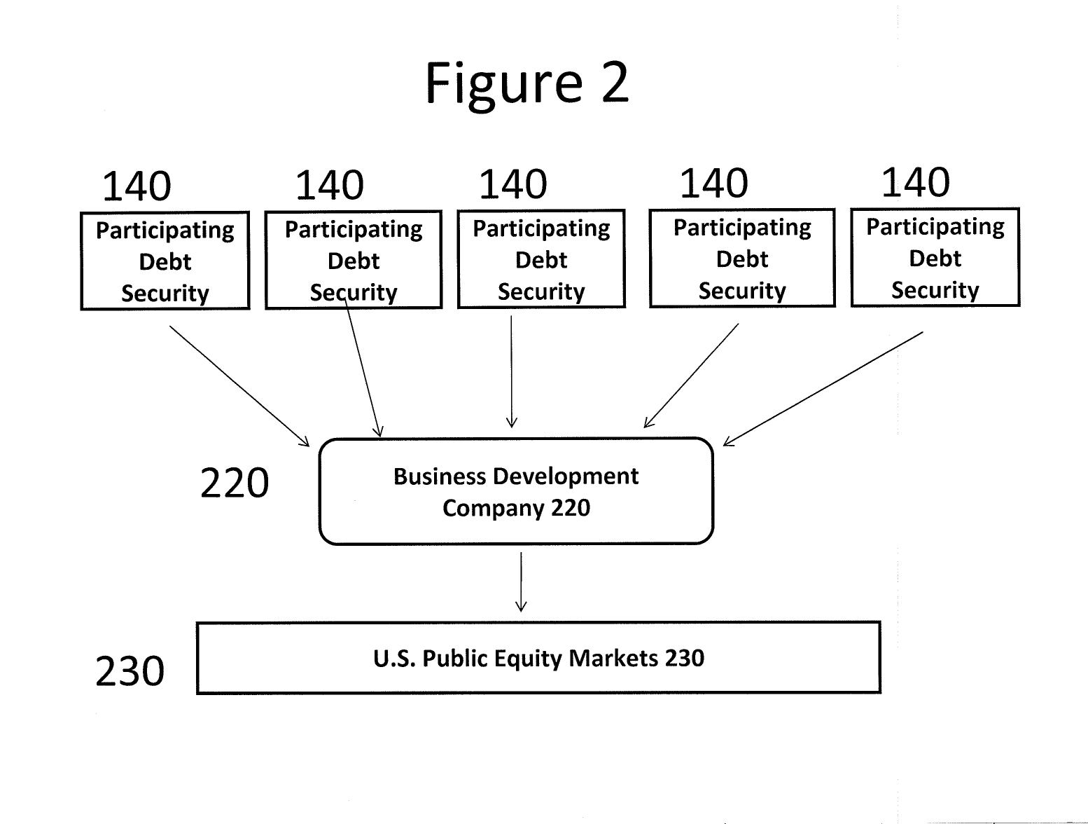

FIG. 2 shows the complete strategy to obtain liquidity through an issuance of a Business Development Company shares according to an embodiment of the present invention. In FIG. 2, the participating debt securities are aggregated and contributed to a Business Development Company (BDC) 220.

Due to the unique aspects of a BDC 220, it is able to sell stock in the BDC to the U.S. public market investors 230 without disrupting any of the underlying asset management companies.

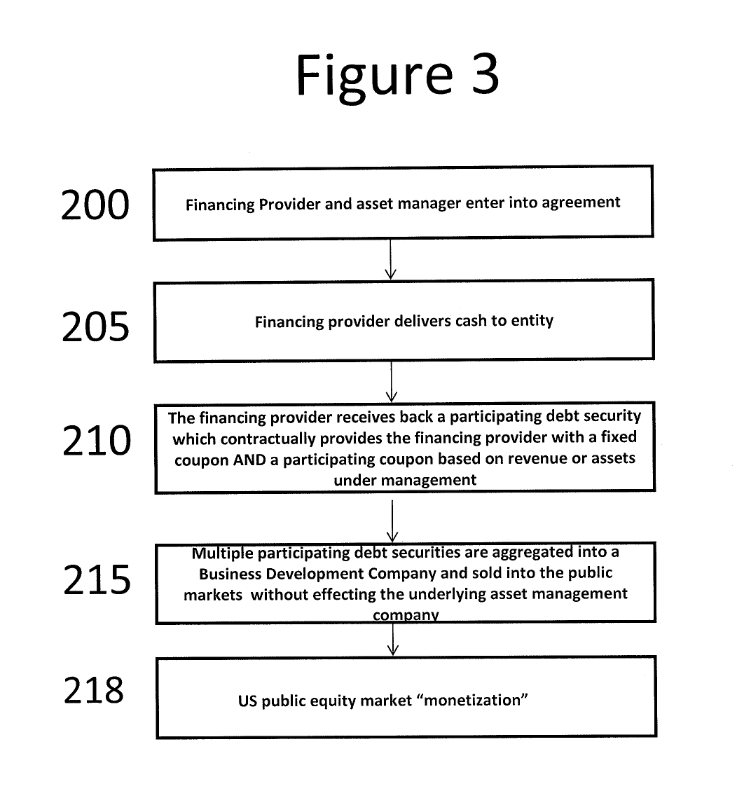

FIG. 3 shows the cash flows from the provider 200, who enters into a legal agreement for the sale of a participating debt security 140 from an asset management entity 120. The financing provider provides assets for the entity 205. For a specified period of time, the financing provider receives an interest payment consisting of both a fixed interest coupon and a participation based on share of revenue generated by the entity or on AUM of the entity 210. No ownership interest in the entity is given to the financing provider during the term of the participating debt security.

The participating debt securities of and other embodiments may be employed to liquefy and diversify the position of entities in fragile situations, such as succession (e.g., a generational transfer of ownership), restructuring, or buyout situations. The investment arrangements may also be used to provide financing for other liquidity or capital needs of the firm or its owners. For instance, arrangements herein can be used to secure funds to pay off a retiring entity principal, as well as to spin off a money-making enterprise.

In an embodiment, a financing provider that is considering the investment arrangements herein may be particularly interested in mid-sized private entities having certain desirable characteristics. Example characteristics for an asset management firm may include: a solid business history; current and expected profitability; a minimum term of consistent validated portfolio performance history; an intermediate-term financing need (e.g., succession, restructuring, buyout); and straightforward governance and structure (that is, for example, a founder in control, or a partnership). Common amongst the group would be a private ownership structure that wishes to remain private, results in the need to find a way to monetize with the investment without forcing the underlying company to be sold to another entity, or buy back its interest, or be sold in a public transaction. The unique “back end” of the BDC 220 is that it allows a monetization event to occur at step 215 by selling shares in a BDC 220 to U.S. public market investors 230 without significant disruption in the underlying companies in which we would invest 230 at step 218.

The amount of financing that a financing provider is willing to provide to an entity may depend on various factors, the main factors being the maturity of the participating debt security and participation percentage of the revenue or AUM. Additionally, as a debt security, the investor will need to assess the likelihood of the return of principal at maturity. It is unlikely that the financing provider will purchase a debt security that is in excess of 50% of the value of the entity. (i.e., the debt investor would want at least a 1 to 1 coverage of value when it entered into the transaction). Additionally, it is unlikely that the management would want to raise value in excess of 50% of the firm's value in a debt transaction either.

Other key terms of the financing may include the maturity of the debt security, the percentage of the revenue participation or participation of AUM, the features of the convertibility feature 420. Hence, terms are a function of multiple factors. In general, the terms may vary based on the coupon, participation interest, convertibility feature and other factors. Further, the longer the term of the revenue share interest obtained, the more the financing provider can afford to finance, all else being equal. In general, the price may be different when the financing provider delivers the financing all up front, absorbing more risk. A computer based model has been designed to assess these different possible relationships between these various factors 420.

In an embodiment, the financing provider receives it's fixed coupon interest payment payments on a semi-annual basis, and its participation interest payments might be semi or annual basis.

In the third part of the invention, the aggregation of the debt securities to be sold as a Business Development Company 220, those interest payments will pass through a business development company to the shareholders of the BDC. Unique to a BDC is that it can be sold to the public WITHOUT significant public disclosure about the underlying investments. As we have described, these investments are generally for small to mid size private entities that do not want to go public themselves. By aggregating them 430, without changing any of their underlying companies (i.e., require a second liquidity event such as a future sale to a third party, or forcing the seller to buy back the interest, or force the seller to go public) we are able to create a unique entity that has enough aggregate cash flows for a public entity but does not require individual company disclosure.

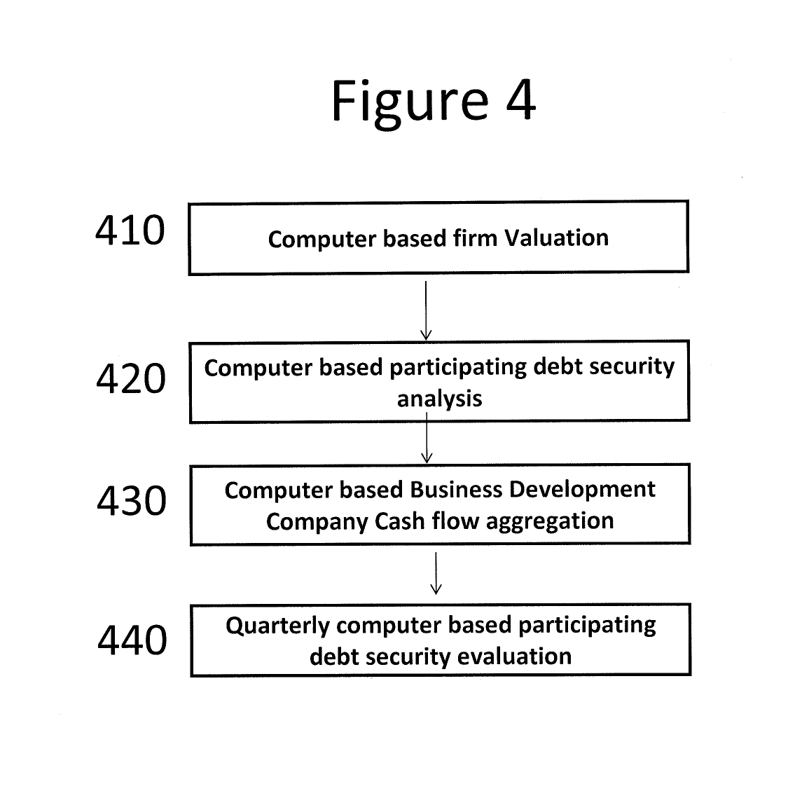

FIG. 4 shows the aspects of the invention that require computer based modeling: To assess the asset management valuation 410, to determine the unique features of the participating debt security 420, a method of aggregating multiple cash flows (including ficed coupons as well as participation coupons) from multiple participating debt securities 430, and the modeling of the asset value of each of these participating debt securities which will be required to be marked to market quarterly for a BDC 440.

Additionally, the BDC structure enables not just a way to monetize the investments, but enables the management of the BDC to raise additional capital to make additional investments in their existing portfolio companies as well as new investments.

Upon a public offering, the BDC would be required to have quarterly valuations of each of its investments. As we would be making these uniquely structured investments we are required to provide a computer based model to evaluate the quarterly changes in the assets prices 440.

In other embodiments, a participating debt security such as described herein may be followed up by one or more subsequent additional participating debt securities between an entity and a financing provider. Such flexibility allows for continued investment in a growing entity, without a loss in entity independence. Such flexibility also permits a first departing partner and later a second departing partner in an asset management firm to monetize their respective holdings, for example.

Various quantitative underwriting criteria may be applied by the financing provider in evaluating an entity for a possible investment arrangement. Example criteria for the asset management industry may include: a minimum level of assets under management (AUM), a minimum period of performance history, domicile in the United States or Canada, transaction size within a specified minimum and maximum size, related leverage underwritten to a minimum standard, a minimum projected IRR (internal rate of return) on investment, client concentration limits, etc. Example client concentration limits may include: no one client more than X % of the asset manager's revenue, the top three clients no more than Y % of the asset manager's revenue, no single asset management firm more than Z % of the financing provider's revenue, and the three largest asset manager relationships no more than W % of the financing provider's revenue.

Various qualitative underwriting criteria also may be applied to an asset management firm. For instance, a new investment arrangement with an entity may be subject to one or more of the following guidelines and objectives: stability of entity management; limited client turnover at entity; entity compliance with investment styles and objectives; sufficiency and stability of entity cash flow and operating margins; consistency of entity revenue sources and rates; and overall financing provider diversity of investment styles, asset classes and industry/sector exposures.

The participating debt security purchased by the financing provider and sold by the asset management firm may include various terms and conditions to appropriately safeguard the financing provider's investment. Example terms and conditions would include typical terms and conditions of any debt security as well there might also include: employment and non-solicitation agreements from key employees; compliance with fundamental investment objectives; maintenance of core pricing economics; limitations on debt and guarantees; negative pledge on revenue and assets related to the participating convertible debt security; and restrictions on disposal of firm assets.

In assessing whether to invest in an entity as described herein and, if so, how much and under what terms and conditions, the financing provider may use a probabilistic model that examines, among other things, the underlying AUM of the entity, historical revenue performance (e.g., growth pattern, risk, volatility), client behavior, and other factors, to forecast the expected revenue/asset growth of the entity, and therefore, the financing provider's forecasted return 410. This revenue/asset forecast is then used as the basis to set the terms of the financing. Such a model may include prediction of possible revenue outcomes over time, with a consideration of interdependent market conditions, performance relative to the market, market cycles, retention, loss, and gain of clients and shareholders, and moral and legal issues.

The pricing ultimately agreed to by the financing provider may reflect the financing provider's return goals, as well as its tolerance of risk and the various features of the participating debt security.

As shown in FIG. 4, various assumptions are used and multiple computer based models are used to arrive at a firm valuation 410. Example features of that computer based analysis would include deterministic growth rates, the replication of specific historic market or asset management firm environments, and shifts in asset mix. Similarly, the hypothetical investment may be examined under discounted cash flow (DCF) methodologies, where cash flows are projected using expected asset growth rates. Additionally, computer based models assessing the asset management fees/revenues/EBITDA might be used to assess a multiple valuation. Additionally, non quantitative measures will be assessed, including management, litigation, and documentation issues with respect to the entity may be considered. If the qualitative assessment is positive, then the transaction is approved, then the participating debt security can be finalized 420.

Once the firm valuation model is finalized, a separate computer based model is used to define the specific terms of the participating debt security 420. The terms include the maturity of the investment, the nature of the fixed coupon (fixed or floating coupon) and the participation feature whether it is based on revenue or a function of AUM.

Once a participating debt security is finalized, a separate computer based model is used to aggregate the cash flows of the various securities to create the basis for the BDC entity 430. These computer based models will summarize existing cash flows and create a basis to project cash flows for existing securities based on assumptions for future participation payments for each individual investment.

Additionally, as a BDC, we would be required to provide quarterly valuations of each of our investments. A computer based model would be used for each individual asset to assess its valuation independently of any other valuation 440. This is would require developing and adjusting projections and assumptions for each individual manager associated with its unique business.

In an example embodiment, analytical processes described herein may be implemented using Microsoft Excel running on a computer, such as a personal computer or a laptop. Such an open architecture may facilitate auditing of processes applied by a financing provider. Existing analytical frameworks (e.g., style analysis) or third party software may be employed for various analytical components. Datasets for analysis may be obtained from various sources, such as, for example, Morningstar, PSN, and Ibbotson & Associates.

In an embodiment, the financing provider enters into investment arrangements with numerous entities in need of capital. The financing provider considers risks and benefits associated with particular entities, but also considers an aggregated picture of its investments, seeking broad diversification among entities. The various entities would then be held in a Business Development Company which would seek to sell equity in the U.S. in a public offering of common shares in the BDC WITHOUT significant disruption for any of the underlying entities in which it has investments 230.

The foregoing description of the various embodiments of the present invention is provided to enable any person skilled in the art to make and use the present invention and its embodiments. Various modifications to these embodiments are possible, and the generic principles presented herein may be applied to other embodiments as well.

It will be apparent to one of ordinary skill in the art that some of the embodiments as described hereinabove may be implemented in many different embodiments of software, firmware, and hardware in the entities illustrated in the figures. The actual software code or specialized control hardware used to implement some of the present embodiments is not limiting of the present invention.

Moreover, the processes associated with some of the present embodiments may be executed by programmable equipment, such as computers. Software that may cause programmable equipment to execute the processes may be stored in any storage device, such as, for example, a computer system (non-volatile) memory, an optical disk, magnetic tape, or magnetic disk. Furthermore, some of the processes may be programmed when the computer system is manufactured or via a computer-readable medium at a later date. Such a medium may include any of the forms listed above with respect to storage devices and may further include, for example, a carrier wave modulated, or otherwise manipulated, to convey instructions that can be read, demodulated/decoded and executed by a computer.

A “computer” or “computer system” may be, for example, a wireless or wireline variety of a microcomputer, minicomputer, laptop, personal data assistant (PDA), wireless e-mail device (e.g., BlackBerry), cellular phone, pager, processor, or any other programmable device, which devices may be capable of configuration for transmitting and receiving data over a network. Computer devices disclosed herein can include data bases, as well as memory for storing certain software applications used in obtaining, processing and communicating data. It can be appreciated that such memory can be internal or external. The memory can also include any means for storing software, including a hard disk, an optical disk, floppy disk, ROM (read only memory), RAM (random access memory), PROM (programmable ROM), EEPROM (electrically erasable PROM), and other computer-readable media.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A method using a computer of financing by a financier for the asset management industry, comprising the steps of:
obtaining a participating debt security in an asset management firm in which the financier is excluded from taking an equity ownership interest during a predetermined period of time determined by the type of participating debt security;
negotiating terms for obtaining a participating debt security in the asset management firm, wherein the participating debt security pays a fixed coupon as well as a participation interest;
providing financing by the financier to the asset management firm based on computer based models for both firm valuation as well as computer based models for the specific features of the participating debt security; and
locating liquidity for a plurality of investments by a Business Development Company (BDC) using computer based modeling of the BDC entity as well as quarterly computer based valuations of each individual investment in the BDC.

2. The method of claim 1 wherein said participation interest is a portion of the revenue derived from asset management or a payment based assets under management (“AUM”).

3. The method of claim 1 wherein the participating debt security may have a convertibility feature that can be converted into a fixed percentage ownership interest in the asset management firm or into a revenue share interest into the asset management firm.

4. The method of claim 1, wherein the financing is provided to the asset management firm in connection with a succession, restructuring, buyout event or other liquidity or capital needs of the firm or its owners.

5. The method of claim 1, further comprising: upon maturity of the convertible participating debt security either receiving the principal amount of the debt security or possibly converting into an equity interest in the asset management firm or into a revenue share interest in the asset management firm.

6. The method in claim 1, further comprising:
aggregating a number of the participating debt securities in a single industry into a specific type of company; and
selling equity interest in the BDC on a national exchange into the U.S. public markets.

7. The method in claim 6, wherein the single industry is an asset management industry and the specific type of company is a Business Development Company

8. The method in claim 1, wherein the negotiated terms includes at least one of the following: a fixed maturity, a fixed coupon on the security, a participation percentage of revenue or a payment based on AUM, a payment schedule on the interest payments, convertibility features into the equity interest or into a perpetual revenue share interest of the firm, call features, one or more required employment agreements for one or more employees, one or more required non-solicitation agreements for one or more employees, one or more objectives, pricing economics, one or more debt limitations, one or more debt guarantees, one or more negative pledges on revenue, one or more negative pledges on assets, priority, or one or more asset disposal restrictions.

9. A method using a computer of financing by a financier of a business by obtaining a convertible participating debt security in the business, and excluding the financier from taking an ownership interest during a predetermined period of time but with a conversion option to convert into a revenue share interest of the business or into the equity ownership of the business, the method comprising:
negotiating terms for the participating convertible debt security; and
evaluating the asset management firm using the computer.

10. The method in claim 9, wherein the business is one of an asset management firm, or any other financial services firm.

11. The method in claim 9, wherein the negotiated terms include at least one of the following: a fixed expiration date, a variable expiration date, a perpetual revenue share interest, a percentage of a callable ownership interest, a price of a callable ownership interest, an amount of financing, one or more earn-outs, a payment schedule, one or more buyout provisions, one or more required employment agreements for one or more employees, one or more required non-solicitation agreements for one or more employees, one or more objectives, pricing economics, one or more debt limitations, one or more debt guarantees, one or more negative pledges on revenue, one or more negative pledges on assets, priority, or one or more asset disposal restrictions.

12. An apparatus for the asset management industry to be used by a financier, comprising:
means for obtaining a participating debt security in an asset management firm in which the financier is excluded from taking an equity ownership interest during a predetermined period of time determined by the participating debt security;
means for negotiating terms for obtaining a participating debt security in the asset management firm, wherein the participating debt security pays a fixed coupon as well as a participation interest;
means for providing financing by the financier to the asset management firm based on computer based models for both firm valuation as well as computer based models for the specific features of the participating debt security; and
means for locating liquidity for a plurality of investments by a Business Development Company (BDC) using computer based modeling of the BDC entity as well as quarterly computer based valuations of each individual investment in the BDC.
